(19) United States
(12) Patent Application Publication
(10) Pub. No.: US 2012/0284603 A1
(43) Pub. Date: Nov. 8, 2012

(54) SYSTEMS AND METHODS FOR ONLINE PHYSICIAN DOCUMENTATION AND NOTES

(75) Inventors: Shankar Saibabu, Boston, MA (US); John Foy, Bainbridge Island, WA (US); Matthew Berger, Pleasantvillc, NY (US)

(73) Assignee: General Electric Company, Schenectady, NY (US)

(21) Appl. No.: 13/465,641

(22) Filed: May 7, 2012

Related U.S. Application Data
(60) Provisional application No. 61/483,054, filed on May 5, 2011.

(51) Int. Cl. G06F 17/20

(52) U.S. Cl. 715/224

(57) ABSTRACT

Certain examples provide systems, methods, and articles of manufacture for dynamic, electronic clinician documentation. Certain examples provide a computer-implemented method for providing physician documentation. The example method includes receiving a user input regarding a form to input clinical information regarding a patient. The example method includes providing a selected form for clinician note data entry. The example method includes accepting user input to complete the form. The accepting of user input includes providing text for selection by the user; accepting free text input from the user to augment the selected text; and generating a note based on the selected text augmented by the user free text input. The example method includes storing the note in association with the patient.

### CROSS-REFERENCE TO RELATED APPLICATIONS

This patent claims priority to U.S. Provisional Application Ser. No. 61/483,054, entitled “SYSTEMS AND METHODS FOR ONLINE PHYSICIAN DOCUMENTATION AND NOTES,” which was filed on May 5, 2011 and is hereby incorporated herein by reference in its entirety.

### FIELD OF THE INVENTION

The presently disclosed technology generally relates to electronic clinical documentation of patient information and, more specifically, relates to electronic, dynamic capture of physician documentation.

### BACKGROUND

Information helps provide a more comprehensive patient record and facilitate improved patient diagnosis and treatment. Electronic systems provide electronic medical records, but physicians are often left without appropriate tools for information capture and documentation.

### BRIEF DESCRIPTION

Certain examples provide systems, methods, and articles of manufacture for dynamic, electronic clinician documentation.

Certain examples provide a computer-implemented method for providing physician documentation. The example method includes receiving a user input regarding a form to input clinical information regarding a patient. The example method includes providing a selected form for clinician note data entry. The example method includes accepting user input to complete the form. The accepting of user input includes providing text for selection by the user; accepting free text input from the user to augment the selected text; and generating a note based on the selected text augmented by the user free text input. The example method includes storing the note in association with the patient.

Certain examples provide a tangible computer-readable storage medium including instructions for execution by a processor. The instructions when executed implement a method to provide physician documentation. The example method includes receiving a user input regarding a form to input clinical information regarding a patient. The example method includes providing a selected form for clinician note data entry. The example method includes accepting user input to complete the form. The accepting of user input includes providing text for selection by the user; accepting free text input from the user to augment the selected text; and generating a note based on the selected text augmented by the user free text input. The example method includes storing the note in association with the patient.

Certain examples provide a system to provide electronic physician documentation. The example system includes a processor and a memory to provide a user interface to receive user input and generate clinician documentation. The processor is arranged to provide a selected form for clinician note data entry; accept user input to complete the form including: provide text for selection by the user; accept free text input from the user to augment the selected text; and generate a note based on the selected text augmented by the user free text input; and storing the note in association with the patient.

### BRIEF DESCRIPTION OF THE DRAWINGS

FIG. 1 is a block diagram of an example healthcare environment.

FIG. 2 depicts an example physician notes interface.

FIG. 3 shows an example interface identifying one or more sources of information.

FIG. 4 illustrates an example interface providing a pop-up display of home medications.

FIG. 5 depicts an example interface including a representation of a longitudinal patient history.

FIG. 6 depicts an interface view of a summary of longitudinal patient history extracts.

FIG. 7 illustrates an example interface providing a review of systems available for insertion into a note.

FIG. 8 shows an example general system that can be selected in a system portion of an example interface.

FIG. 9 provides an example interface for information from a physical exam.

FIG. 10 illustrates an example interface by which a user can provide information via multi-state selection of a variable.

FIG. 11 illustrates an example assessment and plan interface.

FIG. 12 provides an example illustrating notation of a complaint or condition along with associated type, impression, orders, and comment.

FIGS. 13-14 illustrate example builder tools using inputs to generate a resulting template or other form.

FIG. 15 illustrates a flow diagram for an example method or workflow to facilitate dynamic generation of documentation including medical information for a patient.

FIG. 16 is a block diagram of an example processor system that may be used to implement the systems, apparatus and methods described herein.

The following detailed description of certain implementations of the methods, apparatus, systems, and/or articles of manufacture described herein, will be better understood when read in conjunction with the appended drawings. It should be understood, however, that the methods, apparatus, systems, and/or articles of manufacture described herein are not limited to the arrangements and instrumentality shown in the attached drawings.

### DETAILED DESCRIPTION OF CERTAIN EXAMPLES

Although the following discloses example methods, apparatus, systems, and articles of manufacture including, among other components, firmware and/or software executed on hardware, it should be noted that such methods, apparatus, systems, and/or articles of manufacture are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

When any of the appended claims are read to cover a purely software and/or firmware implementation, at least one of the elements in an at least one example is hereby expressly defined to include a tangible medium such as a memory, DVD, CD, Blu-ray, etc. storing the software and/or firmware.

Certain examples provide integrated healthcare clinical and financial software solutions to help streamline workflow, facilitate collaboration, and improve productivity across a continuum of care. Certain examples help enhance patient safety, increase efficiency and productivity, and enhance the quality of care available. Certain examples provide an integrated platform to help achieve a meaningful-use objective of continuity of care. For example, patients can be followed by clinicians at any location in a hospital system. Certain examples allow medical professionals to set workflow alerts for patients with specific conditions and allow doctors and other clinicians to follow the patients over time.

Certain examples provide online physician documentation. Certain examples provide physician-oriented note writing. Certain examples provide and/or interact with medical record(s) relating to a patient and/or medical support database(s) including medical guidelines for diagnosis and/or treatment of a medical condition.

Certain examples provide a clinical knowledge platform that enables healthcare institutions to improve performance, reduce cost, touch more people, and deliver better quality globally. In certain examples, the clinical knowledge platform enables healthcare delivery organizations to improve performance against their quality targets, resulting in better patient care at a low, appropriate cost.

Certain examples facilitate better control over data. For example, certain example systems and methods enable care providers to access real-time patient information from existing healthcare information technology (IT) systems together in one location and compare this information against evidence-based best practices.

Certain examples facilitate better control over process. For example, certain example systems and methods provide condition- and role-specific patient views enable a user to prioritize and coordinate care efforts with an institution's agreed upon practice standards and to more effectively apply resources.

Certain examples facilitate better control over outcomes. For example, certain example systems and methods provide patient dashboards that highlight variations from desired practice standards and enable care providers to identify most critical measures within the context of performance-based care.

Certain examples leverage existing IT investments to standardize and centralize data across an organization. In certain examples, this includes accessing multiple systems from a single location, while allowing greater data consistency across the systems and users.

Entities of healthcare enterprises operate according to a plurality of clinical workflows. Clinical workflows are typically defined to include one or more steps or actions to be taken in response to one or more events and/or according to a schedule. Events may include receiving a healthcare message associated with one or more aspects of a clinical record, opening a record(s) for new patient(s), receiving a transferred patient, and/or any other instance and/or situation that requires or dictates responsive action or processing. The actions or steps of a clinical workflow may include placing an order for one or more clinical tests, scheduling a procedure, requesting certain information to supplement a received healthcare record, retrieving additional information associated with a patient, providing instructions to a patient and/or a healthcare practitioner associated with the treatment of the patient, and/or any other action useful in processing healthcare information. The defined clinical workflows can include manual actions or steps to be taken by, for example, an administrator or practitioner, electronic actions or steps to be taken by a system or device, and/or a combination of manual and electronic action(s) or step(s). While one entity of a healthcare enterprise may define a clinical workflow for a certain event in a first manner, a second entity of the healthcare enterprise may define a clinical workflow of that event in a second, different manner. In other words, different healthcare entities may treat or respond to the same event or circumstance in different fashions. Differences in workflow approaches may arise from varying preferences, capabilities, requirements or obligations, standards, protocols, etc. among the different healthcare entities.

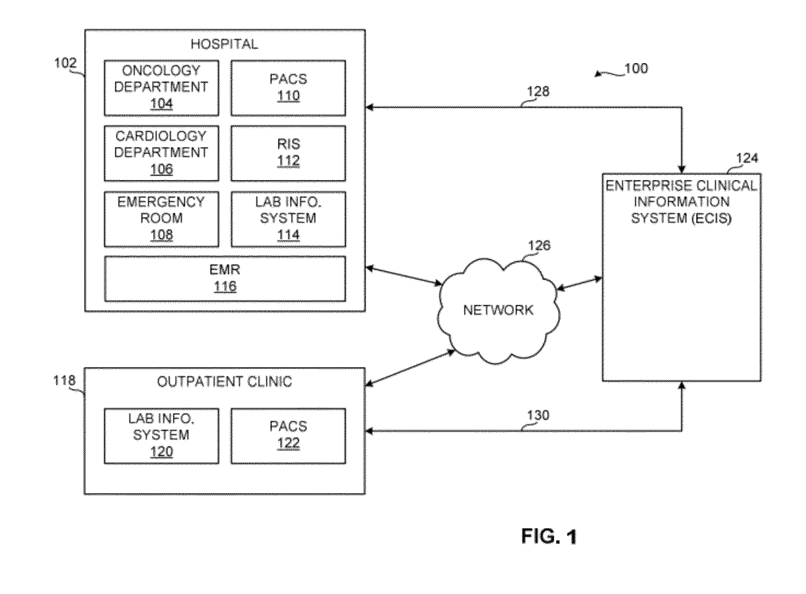

FIG. 1 is a block diagram of an example healthcare environment 100 in which the example methods, apparatus, systems, and/or articles of manufacture disclosed herein for physician notes and other documentation may be implemented. The example healthcare environment 100 of FIG. 1 includes a first hospital 102 having a plurality of entities operating within and/or in association with the first hospital 102. In the illustrated example, the entities of the first hospital 102 include an oncology department 104, a cardiology department 106, an emergency room system 108, a picture archiving and communication system (PACS) 110, a radiology information system (RIS) 112, and a laboratory information system (LIS) 114. The oncology department 104 includes cancer-related healthcare practitioners, staff and the devices or systems that support oncology practices and treatments. Similarly, the cardiology department 106 includes cardiology-related healthcare practitioners, staff and the devices and/or systems that support cardiology practices and treatments. Notably, the example oncology department 104 of FIG. 1 has specifically designed clinical workflows to be executed in response to certain events and/or according to a schedule. At the same time, the example cardiology department 106 of FIG. 1 has specifically designed clinical workflows to be executed in response to certain events and/or according to a schedule that differ from the clinical workflows of the example oncology department 104 of FIG. 1. For example, the oncology department 104 may execute a first set of actions in response to receiving a Healthcare Level 7 (HL7) admission-discharge-transfer (ADT) message, while the cardiology department 106 executes a second set of actions different from the first set of actions in response to receiving a HL7 ADT message. Such differences may also exist between the emergency room 108, the PACS 110, the RIS 112 and/or the accounting services 114.

Briefly, the emergency room system 108 manages information related to the emergency care of patients presenting at an emergency room of the hospital 102, such as admission information, observations from emergency examinations of patients, treatments provided in the emergency room setting, etc. The PACS 110 stores medical images (e.g., x-rays, scans, three-dimensional renderings, etc.) as, for example, digital images in a database or registry. Images are stored in the PACS 110 by healthcare practitioners (e.g., imaging technicians, physicians, radiologists) after a medical imaging of a patient and/or are automatically transmitted from medical imaging devices to the PACS 110 for storage. The RIS 112 stores data related to radiology practices such as, for example, radiology reports, messages, warnings, alerts, patient scheduling information, patient demographic data, patient tracking information, and/or physician and patient status monitors, as well as enables exam order entry (e.g., ordering an x-ray of a patient) and image and film tracking (e.g., tracking identities of one or more people that have checked out a film). The lab information system 114 stores clinical information such as lab results, test scheduling information, corresponding practitioner(s), and/or other information related to the operation(s) of one or more labs at the corresponding healthcare facility. While example types of information are described above as being stored in certain elements of the hospital 102, different types of healthcare data may be stored in one or more of the entities 104-114, as the entities 104-114 and the information listed above is included herein as non-limiting examples. Further, the information stored in entities 104-114 may overlap and/or be combined into one or more of the entities 104-114. Each of the example entities 104-114 of FIG. 1 interacts with an electronic medical record (EMR) system 116. Generally, the EMR 116 stores electronic copies of healthcare records associated with, for example, the hospital 102 and the entities 104-114 thereof.

The example healthcare environment 100 of FIG. 1 also includes an outpatient clinic 118 as an example of another healthcare enterprise. The example outpatient clinic 118 of FIG. 1 includes a lab information system 120 and a PACS 122 that operate similarly to the corresponding entities of the example hospital 102. The lab information system 120 and the PACS 122 of the example outpatient clinic 118 operate according to specifically designed clinical workflows that differ between each other and the clinical workflows of the entities 104-114 of the hospital 102. Thus, differences in clinical workflows can exist between the entities of a healthcare enterprise and between healthcare enterprises in general.

In the illustrated example of FIG. 1, the hospital 102 and the outpatient clinic 118 are in communication with an enterprise clinical information system (ECIS) 124 via a network 126, which may be implemented by, for example, a wireless or wired Wide Area Network (WAN) such as a private network or the Internet, an intranet, a virtual private network, a wired or wireless Local Area Network, etc. More generally, any of the coupling(s) described herein may be via a network. Additionally or alternatively, the example hospital 102 and/or the example outpatient clinic 118 are in communication with the example ECIS 124 via direct or dedicated transmission mediums 128 and 130.

Generally, the ECIS 124 supports healthcare information processing implemented by systems, devices, applications, etc. of healthcare enterprises, such as the hospital 102 and the outpatient clinic 118. The ECIS 124 is capable of processing healthcare messages from different entities of healthcare enterprises (e.g., the entities 104-114 of the hospital 102) that may generate, process and/or transmit the healthcare messages differently and/or using different formats, protocols, policies, terminology, etc. when generating, processing, and/or transmitting the healthcare messages. Moreover, the example ECIS 124 of FIG. 1 supports healthcare practitioners in decision making processes by aggregating healthcare information across disparate enterprises and/or entities thereof and referencing collection(s) of data to automatically generate suggestive and/or definitive data for communication to one or more healthcare practitioners related to the aggregated healthcare information.

Certain examples provide a library of standardized clinical content and proven best practices. Over time, this “library” of content may expand as healthcare organizations add to their own content modules. Because the content is standardized it can be shared and leveraged among organizations using the library and associated clinical knowledge platform. The library and platform help enable organizations to share best practice content. Thus, certain examples provide a clinical knowledge platform that enables healthcare delivery organizations to improve performance against their quality targets.

In certain examples, the ECIS 124 supports and/or includes physician documentation, including online (e.g., Web-based and/or portal accessible) physician documentation and/or physician-focused note writing. Physician in-patent notes can include an admitting note (e.g., admitting history and physical), a progress note, a (preliminary) procedure note (e.g., bedside procedures, operative notes by a surgeon after a procedure, etc), a (preliminary) consult note, a resident/attending note, etc. Emergency Department (ED) physician notes (e.g., multi-author notes), ambulatory notes, discharge notes, handoff notes, (preliminary) nursing assessment notes, physician charge capture notes, and/or specialty notes, etc., can similarly be provided. In certain examples, a notes template is configurable by customer. In certain examples, notes can be integrated with a flowsheet, orders, etc.

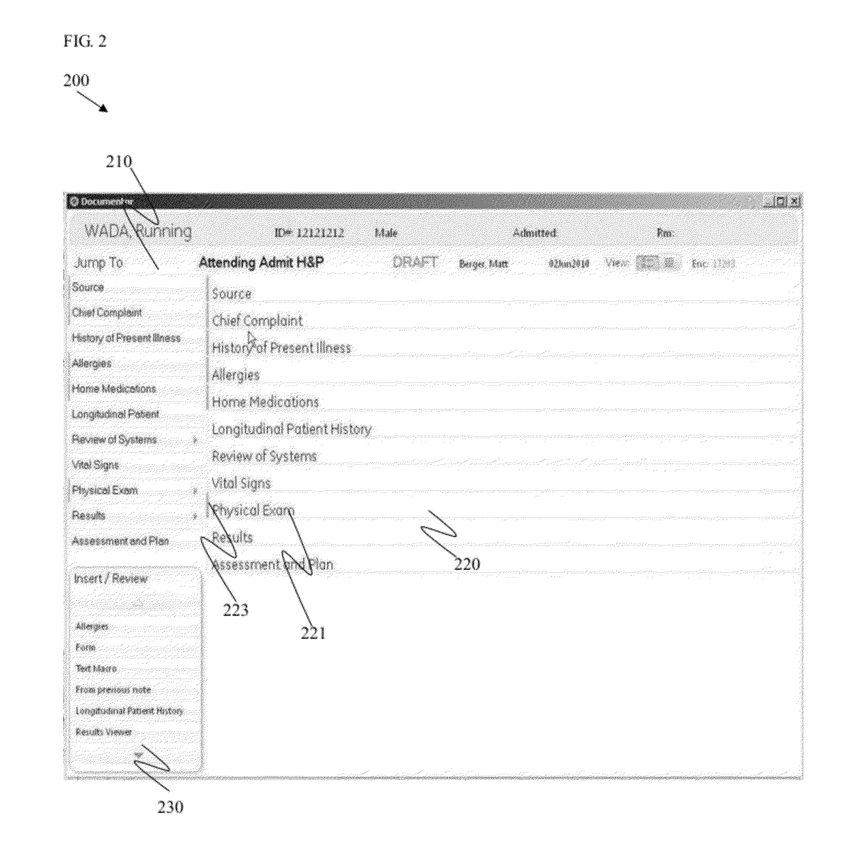

FIG. 2 depicts an example physician notes interface 200. A navigation pane 210 on a left side of the interface 200 corresponds to content for display in a main pane 220. Information and/or options shown in the navigation pane 210 may increase as more content is added in the main pane 220, for example. One or more components 230 (e.g., insert/review) are displayed at the bottom left of the example interface 200. The component(s) 230 list options that could be placed on the main pane 220 of the note template but are not currently present.

The main pane 220 includes one or more information items or sections 221. Data can be entered regarding one or more of the displayed information items 221. Items 221 can include a source, chief complaint, history of present illness, allergies, home medications, longitudinal patient history, review of systems, vital signs, physical exam, results, assessment and plan, etc. In certain examples, a status bar 223, such as a color-coded graphical bar, can be displayed in conjunction with an information item 221 to indicate a status with respect to that item 221. For example, a green or other color bar indicates status. Green indicates that something has been entered for the item 221, for example. No bar indicates that no data has been entered. A section with a red bar indicates that required data that has not yet been entered for that item 221, for example. A yellow bar indicates that information has been highlighted as pertinent for the user's attention, for example.

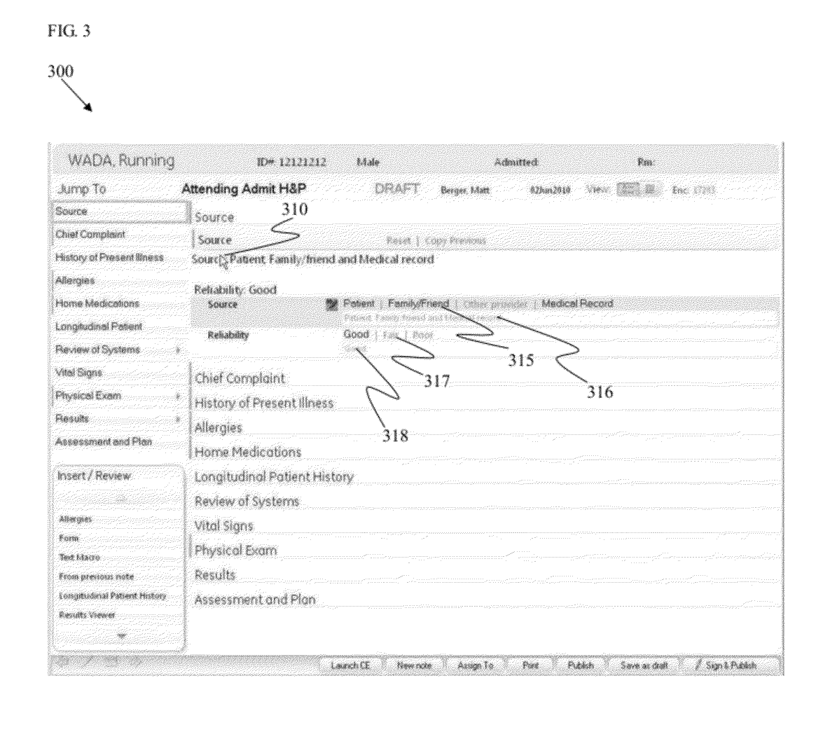

As shown in the example interface 300 of FIG. 3, one or more sources 310 of information are identified. The source(s) 310 are built into a note resulting from user input via the interface 300 along with the related information. As illustrated in the example of FIG. 3, the interface 310 provides structured selection of notes or descriptors 315, 317 for a patient record. Additionally, a comment line 316, 318 is filled in with the selected text 315, 317, but can also be editable by a user to directly change or augment the filled in notes with user text.

In certain examples, the interface 300 includes a highlighter icon to highlight one or more selected items. In certain examples, the interface 300 can be viewed in a form view or a text view. The text view shows actual note output and displays highlighted items as highlighted in that view.

In certain examples, items of information can be automatically pulled into a note from a database and/or other record (e.g., using a script and/or macro). In certain examples, a macro can be used in any text field. In certain examples, one or more variables can be used in the macro to pull data, and/or pull-down menus can be provided to allow a user to select one or more fields. For example, allergy information for a patient can be populated by an automatic data pull from a data base for allergy and reaction.

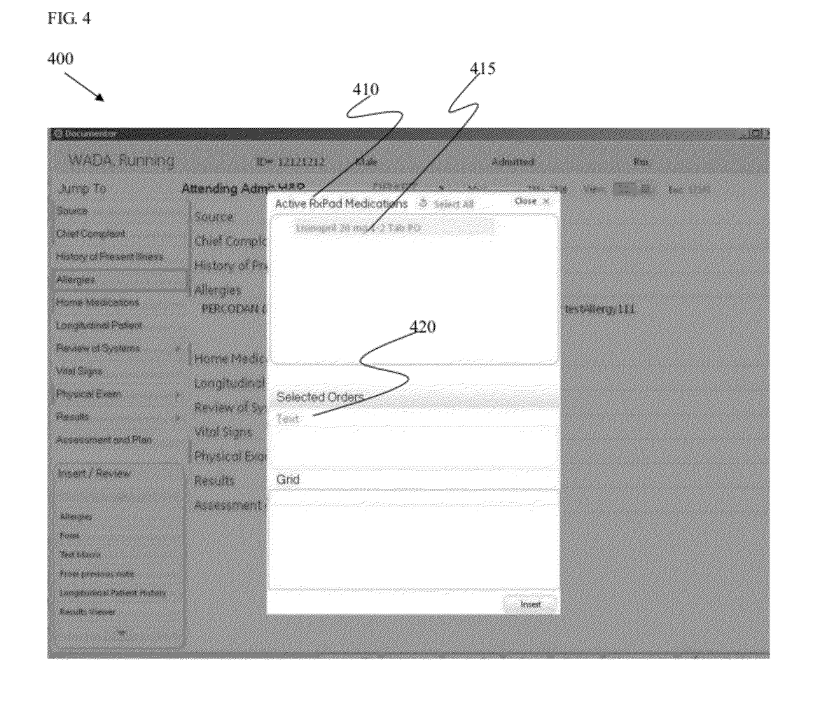

FIG. 4 illustrates an example interface 400 providing a pop-up display 410 of home medications. As shown in the example of FIG. 4, the pop-up 410 is displayed with the interface 400 background grayed out so that a user can maintain his/her orientation but maintain attention focused on the pop-up 410. The medications pop-up 410 provides a list of patient's outpatient prescriptions 415. A user can select one or all of the medication(s) 415 and drop down into lower components to put them into the note the user is creating. In certain examples, additional text 420 in one or more selected orders can be put into the note.

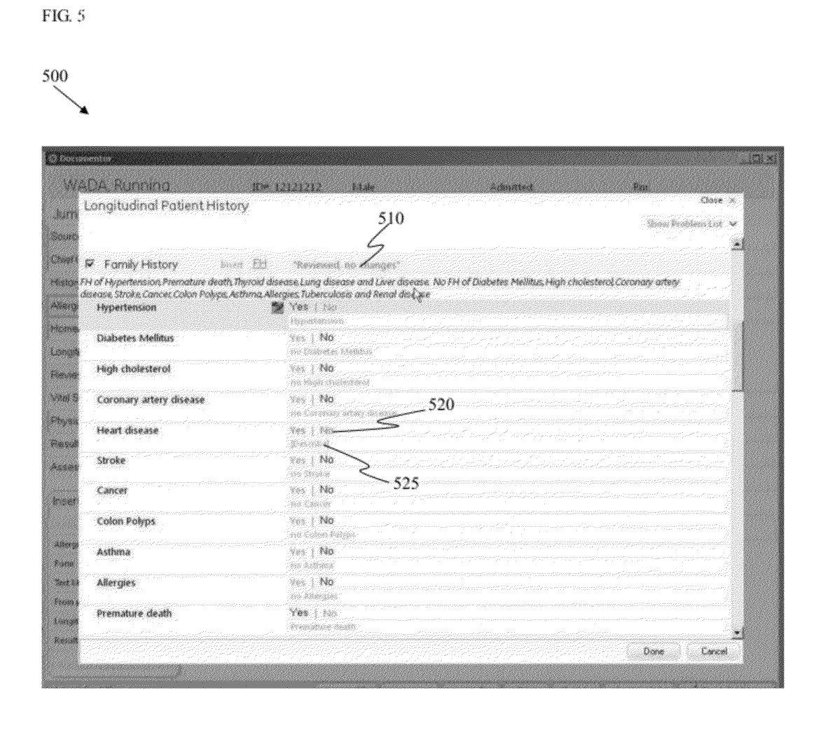

FIG. 5 depicts an example interface 500 including a representation of a longitudinal patient history. For example, past medical history, past surgical history, past family history, past social history, etc., can be provided to the user. The example interface 500 can show a problem list (e.g., a list of medical problems followed for this patient) and a user can insert the information as part of a patient history (e.g., inpatient and/or outpatient).

Using the example interface 500, a user can indicate that the history (e.g., the patient's family history) has been reviewed and no changes are to be made 510. Alternatively, a user can select an option 520 (e.g., yes or no) and comments and/or description 525 are generated based on the selected option. Additional and/or alternative user comments can be entered in the description 525 using free form text, for example. Option selection 520 and comment 525 can be facilitated for each item in the family history.

In certain examples, repeated groups can be provided to a user through the user interface (UI) design. For example, a user can refine a notation of a patient's tobacco use, alcohol, etc. If a user selects anything other than “never”, for example, the interface provides the user with a plurality of boxes for detail. Thus, an iterative process is provided for description and handling of complex associations where there is a finding and a location (e.g., I hear this sound in this part of the chest and I hear another sound in another part of the chest). In certain examples, the information can be pulled in from an external source, added by a user, or indicated as “Reviewed, no changes.”

In certain examples, the longitudinal patient history pop-up is a separate document that exists in a data store (e.g., a database) and is one click away when a user is writing a note. The longitudinal history can be pulled up, placed in a note, and updated, for example.

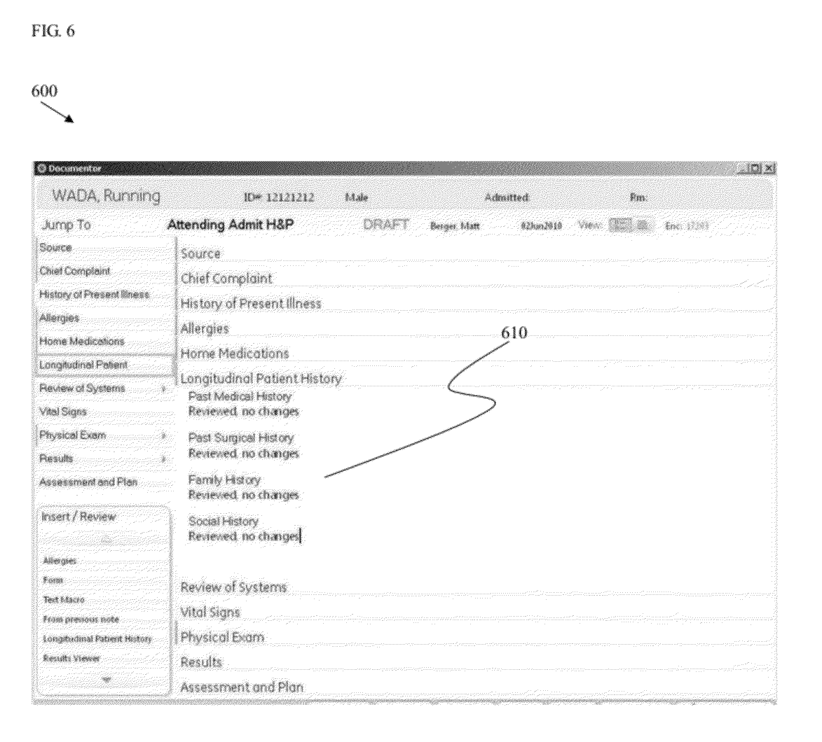

FIG. 6 depicts an interface view 600 of a summary of longitudinal patient history extracts 610. For example, past medical history, past surgical history, family history, and social history summary status 610 are shown via the interface 600. Longitudinal history can be used to aid in diagnosis, treatment, reporting notes, preparation for assessment and planning, etc. Information from the longitudinal history can be modified, updated, incorporated into a report or other document, etc.

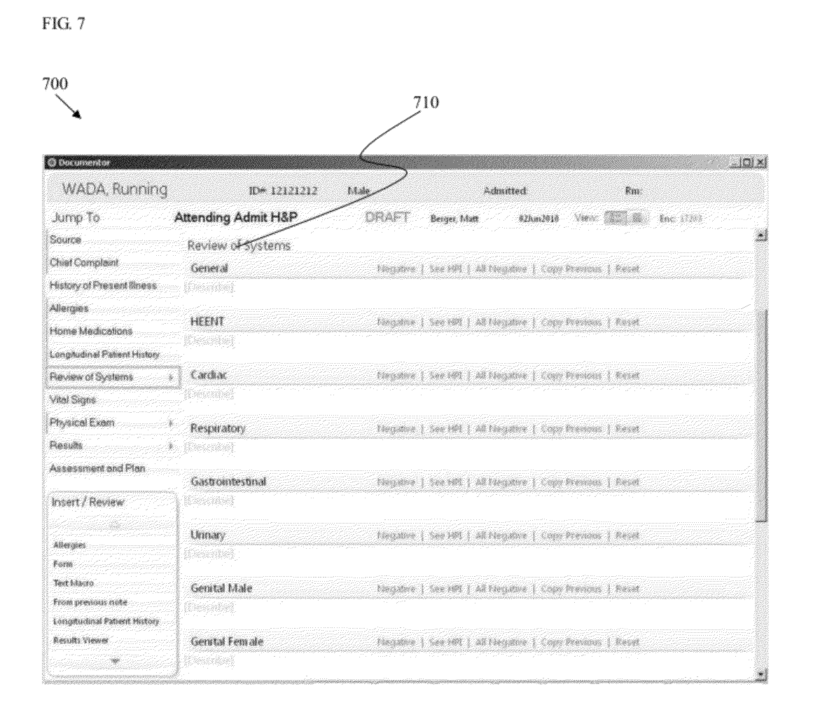

FIG. 7 illustrates an example interface 700 providing a review of systems available for insertion into a note. In certain examples, each system 710 is a separate document accessible via the interface 700. For example, general, head ears eyes nose throat (HEENT), cardiac, respiratory, gastrointestinal, urinary, and genital systems are displayed in the example interface 700. A user can choose what information to see and/or include in a note or report. For example, a user can select negative, see history of present illness (HPI), all negative (if a user wishes to document by exception), copy previous, reset, etc.

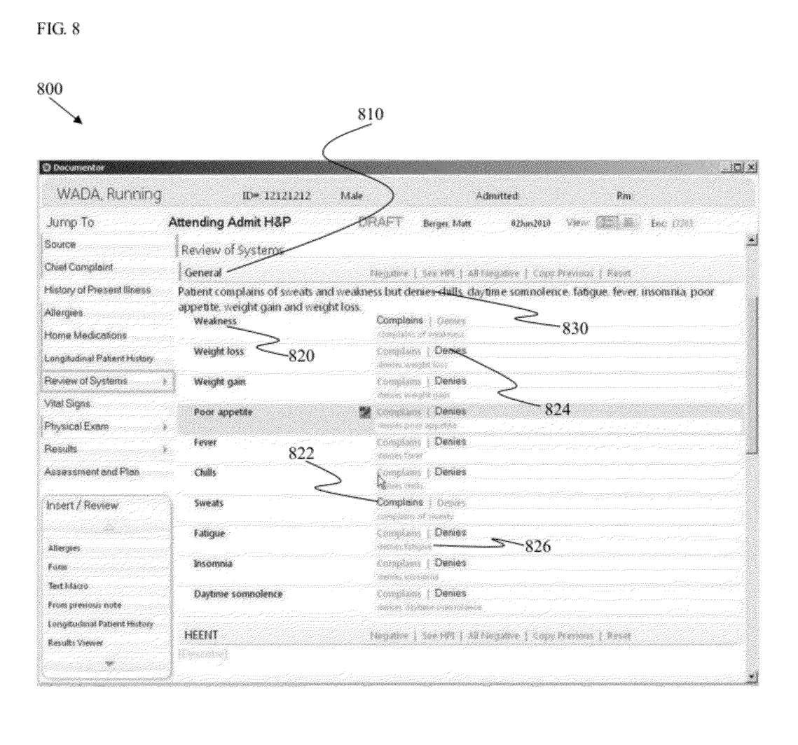

As shown in the example of FIG. 8, a general system 810 can be selected in a system portion of an example interface 800. A statement of a patient complaint 830 can be generated based on user selection of complaint(s) 820 and associated descriptor(s) 822,824, 826. A user can select a complaint 820 (e.g., weakness, weight loss, weight gain, poor appetite, fever, chills, sweats, fatigue, insomnia, daytime somnolence, etc.) and a descriptor (e.g. complains 822 or denies 824) to indicate in text 826, 830 whether the patient complains or denies of the selected condition 820. In certain examples, a user can set all complaints 820 to negative 824 and selectively change the denies 824 as shown in the example of FIG. 8 (e.g., start with all negative 824 and change to positive 822 or change to neutral if the question was not asked). That is, a tri-state control allows a user to select an item (e.g., a word or phrase) via the user interface 800, and each time that item is selected, the value or parameter associated with that item changes (e.g., positive, negative, or neutral). A resulting statement 830 of patient complaint is thus generated from the text entries 826.

In certain examples, billing can be driven based on how complete a user was in asking and answering the provided questions.

In certain examples, vital signs with associated dates can be automatically pulled into a notes interface for user review and selection.

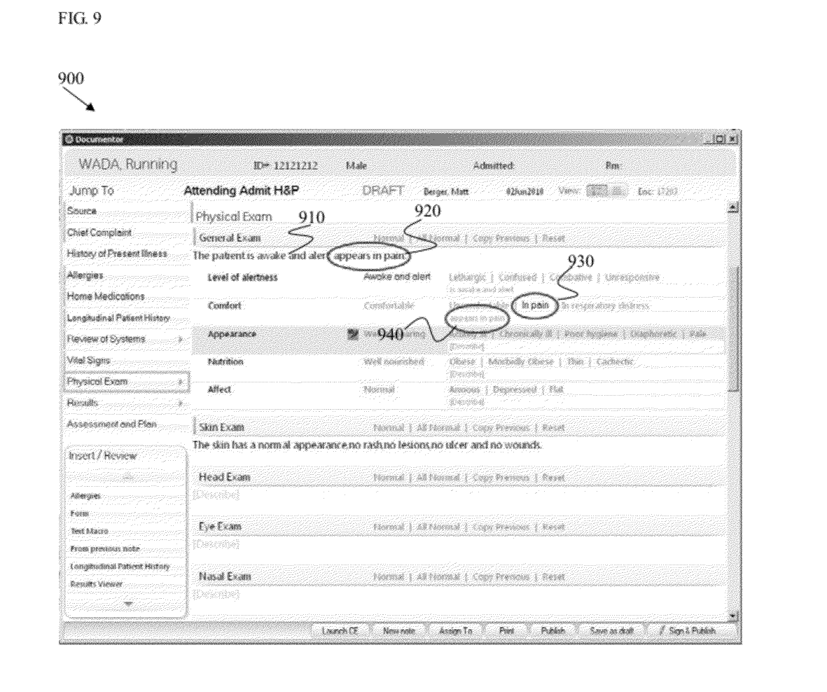

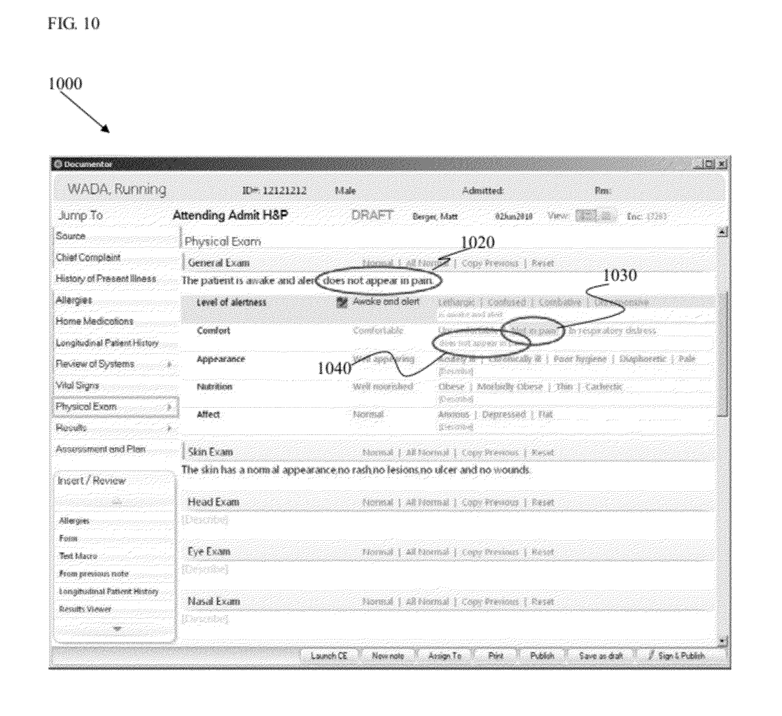

FIG. 9 provides an example interface 900 for information from a physical exam. A user can generate a general exam statement 910 for inclusion in a note by selecting a component and a variable 930. The selected variable is associated with a description 940 and is included 920 in the statement 910. In certain examples, the description 940 can be modified by a user. For example, a user can select “in pain” 930, and the descriptor 940 appears in statement 910. As illustrated in the example interface 1000 of FIG. 10, a user can select “in pain” 930 again and the variable becomes “not in pain” 1030. The associated text 1040 is then provided 1020 in the statement.

In certain examples, the example interface 900, 100 includes a pain level indicator with a spinner, explode variable comfort to provide additional detail, a value, etc. For example, the interface may prompt the user to indicate is there fluid in the ear. If yes, how much and what color. The selected and/or entered values 940 all build in to the text statement of the patient condition 910, 920.

In certain examples, evaluation logic is provided to determine whether a variable is portrayed as X and Y but not Z, versus X and Y and no Z. For example, if a user finds fluid, the user expects the ear to be bulging, so the note generator interface can represent the indicator as fluid but no bulging if the bulging is not found.

In certain examples, pertinent findings can be distinguished from incidental findings. For example, a highlighter allows a user to mark anything as pertinent rather than inferring that the finding is pertinent.

In certain examples, results can be pulled into a note from a database and/or flowsheet (e.g., a data pull from flowsheet in a familiar format for doctors). In certain examples, other clinical information system functionality can be integrated into the note writing.

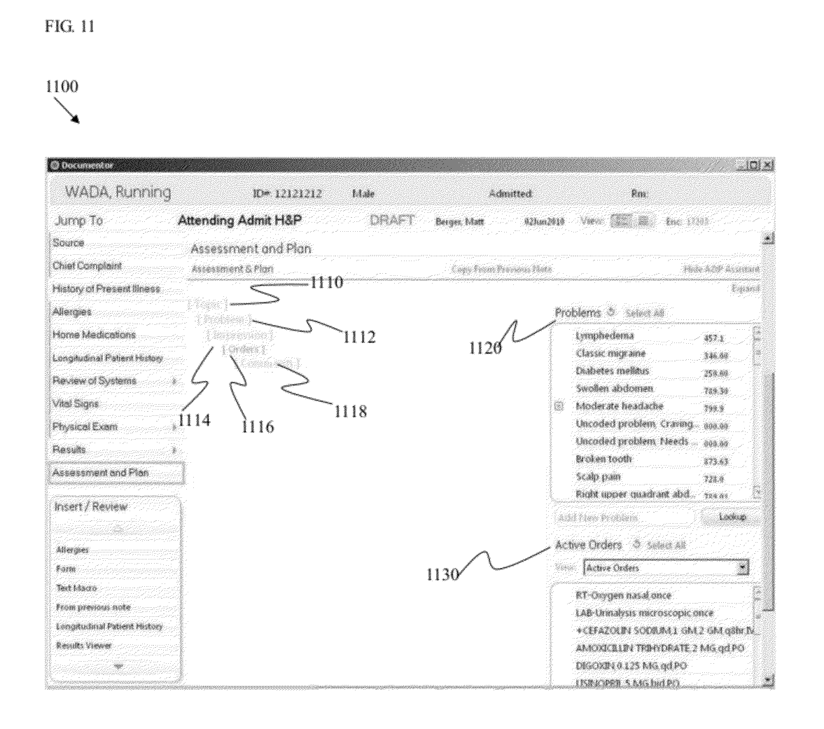

FIG. 11 illustrates an example assessment and plan interface 1100. Using the interface 1100, a user can select a problem and begin typing but can also have an H & P Assistant to select problems and orders. A list can be expanded to see more problems, for example. When a user selects something from a problem list 1120, the selected item is filled in as a problem 1112 under a topic 1110. Then, the user can write an impression (e.g., an assessment) 1114 and then select one or more orders 1116 from an order list 1130. The user can also provide comments 1118 regarding additional instructions, what is next, what is the plan, what else will be checked going forward, etc. The problem list 1120 can be its own component or can be implemented with a text macro, for example. In certain examples, a new problem can be added into a clinical information system from the interface 1100.

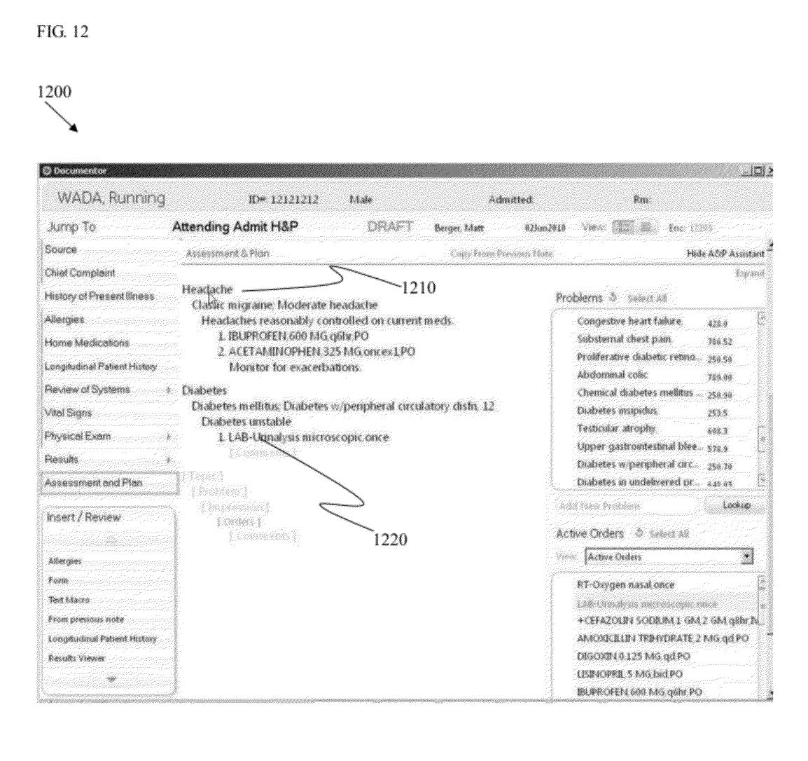

FIG. 12 provides an example illustrating a headache 1210 with associated type, impression, orders, and comment. Additionally, a second topic, diabetes 1220, is documented with type, impression, and order.

Thus, certain examples provide a user with flexibility to arrange information in a note as desired. Certain examples provide generation of a whole note from one workspace area. Certain examples, generate a text-based note that can be printed, saved, transmitted, and/or otherwise output to a user, patient, and/or system.

In certain examples, a note record is generated with a barcode. The barcode helps scan and categorize the record. For example, an examination history and physical (EHP) can be categorized by scanning the barcode.

In certain examples, a patient can add family history, social history, etc., from a kiosk. A practitioner can then comment, evaluate, and/or modify the input information. If information is altered, a provider receives a note indicating that something has changed, and the provider can review and validate the change. In certain examples, notes obtained from a doctor are associated with a higher validity than patient provided information.

In certain examples, fields and default information can be colored coded. For example, blue indicates nothing selected; black indicates selection; gray indicates not selected (can still go back and selected a grayed item unless it is only a one-choice field, for example), etc. By clicking on an item, the user can easily go from neutral, to selected, to not selected, to back to neutral.

In certain examples, users learn as they go, rather than traditional user interface (UI) controls of radio buttons and check boxes. Certain examples provide an easy way to learn how to use outside of forced data collection. However, in certain examples, required fields can be established and configured. In certain examples, note generation interfaces are not cluttered with instructions and instead rely upon a doctor's knowledge of what is mutually exclusive and what is not. The doctor can intuitively figure out information input from using the interface. Thus, certain examples provide more flexibility in UI and control.

In certain examples, a builder tool builds a note generation form based on specified content, and a user can turn on and off the content without the user having to lay out the content and the form. A variable builder and component builder allow a user to define a variable and add it to the component builder and update a form/template as a result. Mapping to a language (e.g., English) is specified in the builder, for example. The language mapping is controllable through the builder.

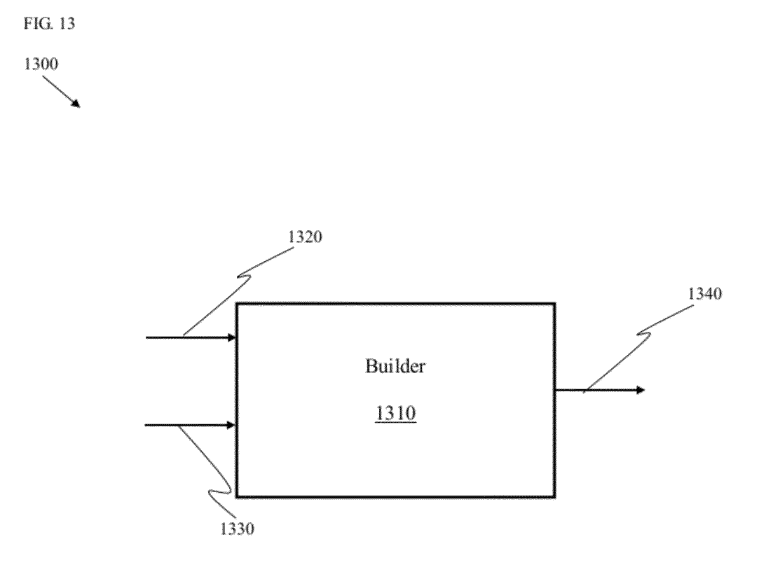

FIG. 13 illustrates an example builder tool 1300 including a builder 1310, a system input 1320, a user input 1330, and an output 1340. Using system 1320 and user 1330 input, the builder 1310 constructs a template or other form to be provided as an output 1340. The output 1340 can be stored as a template in a database, dynamically deployed for use, saved with a report, stored in an electronic medical record, etc.

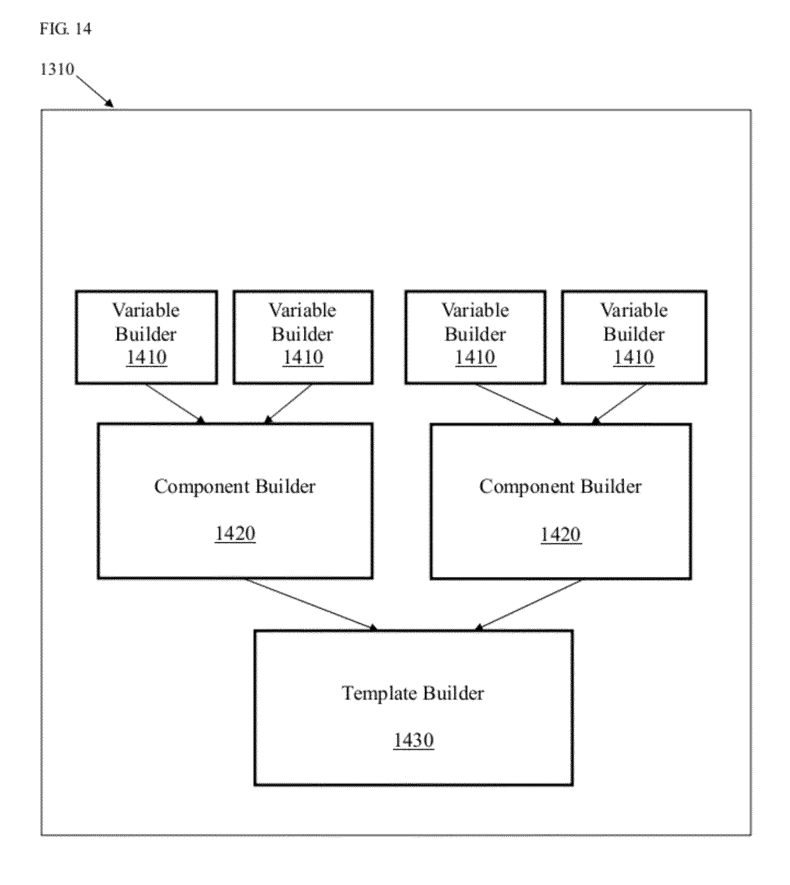

FIG. 14 provides further detail regarding the builder 1310. The example builder 1310 shown in FIG. 14 includes one or more variable builders 1410, one or more component builders 1420, and a template builder 1430. Using the builder 1310, variables are constructed from user and/or system input via the variable builder 1410. One or more generated variables are provided to each of the one or more component builders 1420. The variables are used by the component builder 1420 to generate a component (e.g., a portion of a form/template such as a visualization of pertinent findings, an order entry, a patient data entry, visit notes, trend graph or histogram, etc.). One or more generated components are provided to the template builder 1430 which combines the components to construct a template or other form. The resulting template is made available for display, entry, processing, and/or saving for later use, for example.

Certain examples provide a form with persistent data that a user can access. Certain examples pull data from a database. Monitors and/or sensors may feed into a database, for example.

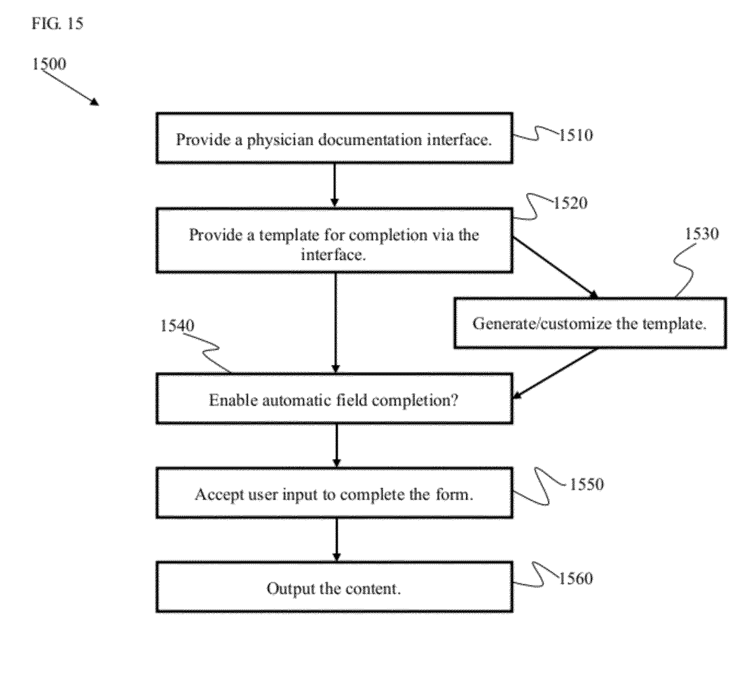

FIG. 15 illustrates a flow diagram for an example method or workflow 1500 to facilitate dynamic generation of documentation including medical information for a patient.

At block 1510, a physician documentation interface is provided. For example, a clinical interface such as an admissions interface, assessment and planning interface, reporting interface, discharge interface, etc., is provided.

At block 1520, a template is provided for physician completion via the interface. For example, a template form with information, instructions and fields to be completed by and/or for a user is provided (e.g., an admitting history and physical form, progress notes, consultant notes, procedure notes (e.g., surgical, emergency department, ambulatory, etc.), etc. The template can be pre-generated and retrieved for display and completion. Alternatively or in addition, at block 1530, the template can be generated and/or customized by and/or for the user. For example, a dynamic template builder can take input and/or retrieve data/functionality to form variables, use the variables to build components, and use the components to construct a template form.

At block 1540, automated field completion can be enabled to assist the user in completing the form, provide default values for user approval or modification, etc. At block 1550, user input is accepted to complete the form. User input can be structured to easily enable the user to provide characteristics for the note being entered, for example. A use can directly select text of an option and leave it as is, replace it, and/or augment it with keyboard entry. Information can be generated based on selections from the patient history, for example. Pieces of shorthand and/or other data can be dynamically converted into more natural language (e.g., English) based on context/circumstances, etc. The form can facilitate iterative selection of an item to handle complex associations between data, for example. Tri-state control can be provided to allow a user to select a word in the form and toggle between a neutral, positive, or negative treatment of the word (e.g., no mention of diabetes, the patient has diabetes, the patient does not have diabetes, etc.), for example.

At block 1560, the content of the form is output. For example, the content of the form can be saved, printed, otherwise transmission, input into an electronic record, routed to another clinical program, imported into a longitudinal patient record, processed by a billing program, etc.

While an example manner of implementing systems and methods have been illustrated in the figures, one or more of the elements, processes and/or devices illustrated in the figures may be combined, divided, re-arranged, omitted, eliminated and/or implemented in any other way. Further, one or more components and/or systems may be implemented by hardware, software, firmware and/or any combination of hardware, software and/or firmware. Thus, for example, any of the example components and/or systems may be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example components and/or systems are hereby expressly defined to include a tangible medium such as a memory, DVD, Blu-ray, CD, etc., storing the software and/or firmware. Further still, any of the example systems may include one or more elements, processes and/or devices in addition to, or instead of, those illustrated in the figures, and/or may include more than one of any or all of the illustrated elements, processes and devices.

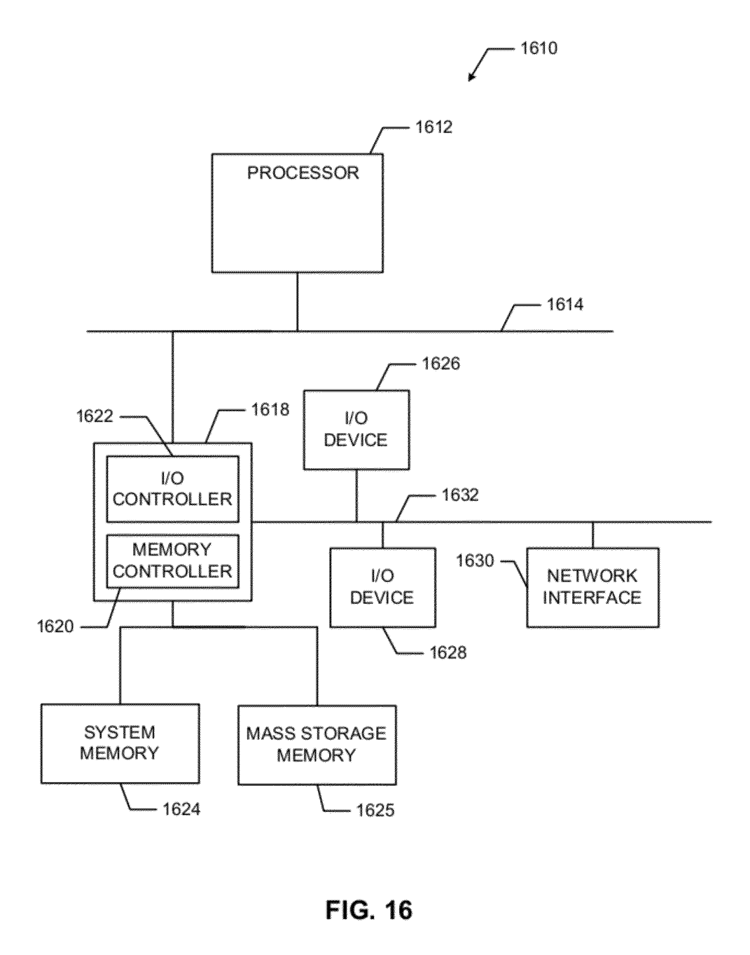

Flow diagrams and/or data flow depicted in and/or associated with the figures are representative of machine readable instructions that can be executed to implement example processes and/or systems described herein. The example processes may be performed using a processor, a controller and/or any other suitable processing device. For example, the example processes may be implemented in coded instructions stored on a tangible medium such as a flash memory, a read-only memory (ROM) and/or random-access memory (RAM) associated with a processor (e.g., the example processor 1612 discussed below in connection with FIG. 16). Alternatively, some or all of the example processes may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes may be implemented manually or as any combination(s) of any of the foregoing techniques, for example, any combination of firmware, software, discrete logic and/or hardware. Further, although the example processes are described with reference to the figures, other methods of implementing the processes of may be employed. For example, an order of execution may be changed, and/or some of the elements described may be changed, eliminated, sub-divided, or combined. Additionally, any or all of the example processes of may be performed sequentially and/or in parallel by, for example, separate processing threads, processors, devices, discrete logic, circuits, etc.

FIG. 16 is a block diagram of an example processor system 1610 that may be used to implement the systems, apparatus and methods described herein. As shown in FIG. 16, the processor system 1610 includes a processor 1612 that is coupled to an interconnection bus 1614. The processor 1612 may be any suitable processor, processing unit or microprocessor. Although not shown in FIG. 16, the system 1610 may be a multi-processor system and, thus, may include one or more additional processors that are identical or similar to the processor 1612 and that are communicatively coupled to the interconnection bus 1614.

The processor 1612 of FIG. 16 is coupled to a chipset 1618, which includes a memory controller 1620 and an input/output (I/O) controller 1622. As is well known, a chipset typically provides I/O and memory management functions as well as a plurality of general purpose and/or special purpose registers, timers, etc. that are accessible or used by one or more processors coupled to the chipset 1618. The memory controller 1620 performs functions that enable the processor 1612 (or processors if there are multiple processors) to access a system memory 1624 and a mass storage memory 1625.

The system memory 1624 may include any desired type of volatile and/or non-volatile memory such as, for example, static random access memory (SRAM), dynamic random access memory (DRAM), flash memory, read-only memory (ROM), etc. The mass storage memory 1625 may include any desired type of mass storage device including hard disk drives, optical drives, tape storage devices, etc.

The I/O controller 1622 performs functions that enable the processor 1612 to communicate with peripheral input/output (I/O) devices 1626 and 1628 and a network interface 1630 via an I/O bus 1632. The I/O devices 1626 and 1628 may be any desired type of I/O device such as, for example, a keyboard, a video display or monitor, a mouse, etc. The network interface 1630 may be, for example, an Ethernet device, an asynchronous transfer mode (ATM) device, an 802.11 device, a DSL modem, a cable modem, a cellular modem, etc. that enables the processor system 1610 to communicate with another processor system.

While the memory controller 1620 and the I/O controller 1622 are depicted in FIG. 16 as separate blocks within the chipset 1618, the functions performed by these blocks may be integrated within a single semiconductor circuit or may be implemented using two or more separate integrated circuits.

Certain examples contemplate methods, systems, apparatus, and/or computer program products on any machine-readable media to implement functionality described above. Certain examples may be implemented using an existing computer processor, or by a special purpose computer processor incorporated for this or another purpose or by a hardwired and/or firmware system, for example.

Certain examples include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Examples may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain methods, systems, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

1. A computer-implemented method for providing physician documentation, the method comprising:
receiving a user input regarding a form to input clinical information regarding a patient;
providing a selected form for clinician note data entry;
accepting user input to complete the form, the accepting of user input comprising:
providing text for selection by the user;
accepting free text input from the user to augment the selected text; and
generating a note based on the selected text augmented by the user free text input; and
storing the note in association with the patient.

2. The method of claim 1, further comprising storing the note as structured data.

3. The method of claim 2, further comprising translating the structured data into a natural language expression.

4. The method of claim 1, wherein providing text for selection by the user further comprises providing iterative selection of text to accommodate complex associations of information for the patient.

5. The method of claim 1, wherein providing text for selection by the user further comprises providing multi-state selectable text for selection by the user.

6. The method of claim 1, wherein the multi-state selectable text allows a user to select the text to toggle among positive, negative and neutral treatment of the text.

7. The method of claim 1, further comprising providing a longitudinal history for the patient embedded with a note generation interface in a user clinical application.

8. A tangible computer-readable storage medium including instructions for execution by a processor, the instructions when executed implementing a method to provide physician documentation, the method comprising:
receiving a user input regarding a form to input clinical information regarding a patient;
providing a selected form for clinician note data entry;
accepting user input to complete the form, the accepting of user input comprising:
providing text for selection by the user;
accepting free text input from the user to augment the selected text; and
generating a note based on the selected text augmented by the user free text input; and
storing the note in association with the patient.

9. The computer-readable medium of claim 8, further comprising storing the note as structured data.

10. The computer-readable medium of claim 9, further comprising translating the structured data into a natural language expression.

11. The computer-readable medium of claim 8, wherein providing text for selection by the user further comprises providing iterative selection of text to accommodate complex associations of information for the patient.

12. The computer-readable medium of claim 8, wherein providing text for selection by the user further comprises providing multi-state selectable text for selection by the user.

13. The computer-readable medium of claim 8, wherein the multi-state selectable text allows a user to select the text to toggle among positive, negative and neutral treatment of the text.

14. The computer-readable medium of claim 8, further comprising providing a longitudinal history for the patient embedded with a note generation interface in a user clinical application.

15. A system to provide electronic physician documentation, the system comprising:
a processor and a memory to provide a user interface to receive user input and generate clinician documentation, the processor arranged to:
provide a selected form for clinician note data entry;
accept user input to complete the form including:
provide text for selection by the user;
accept free text input from the user to augment the selected text; and
generate a note based on the selected text augmented by the user free text input; and
storing the note in association with the patient.

16. The system of claim 15, further comprising storing the note as structured data.

17. The system of claim 15, wherein providing text for selection by the user further comprises providing iterative selection of text to accommodate complex associations of information for the patient.

18. The system of claim 15, wherein providing text for selection by the user further comprises providing multi-state selectable text for selection by the user.

19. The system of claim 15, wherein the multi-state selectable text allows a user to select the text to toggle among positive, negative and neutral treatment of the text.

20. The system of claim 15, wherein the user interface is to provide a longitudinal history for the patient embedded with a note generation interface in a user clinical application.
